(19) United States
(12) Patent Application Publication
(10) Pub. No.: US 2014/0067196 A1
(43) Pub. Date: Mar. 6, 2014

(54) Warning System for Vehicles

(71) Applicant: Shui-De Chen, Shuishang Township (TW)

(72) Inventor: Shui-De Chen, Shuishang Township (TW)

(21) Appl. No.: 13/604,915

(22) Filed: Sep. 6, 2012

(51) Int. Cl. G06F 7/00; G01M 17/00

(52) U.S. Cl. 701/32.8; 701/33.9

(57) ABSTRACT

A warning system for vehicles contains a detecting device for capturing different change values of an internal resistance coefficient generating from a water quantity of an outlet tube of a water tank and different change values relative to a float voltage; a detection module used to determine the different change values of the internal resistance coefficient generating from the water quantity of the outlet tube of the water tank and captured by the detecting device and to determine the different change values relative to the float voltage, and then to compare the internal resistance coefficient and the float voltage with a predetermined standard coefficient, thus determining if the warning system is normal and amplifying an output signal to make sounds. Thereby the detection module, the detecting device, and a car housing form an electricity conducting circuit so that detection and alert are obtained automatically.

### BACKGROUND OF THE INVENTION

1. Field of the Invention

The present invention relates to a warning system, and more particularly to a warning system that allows detecting different change values of an internal resistance coefficient generating from a water quantity of an outlet tube of a water tank or allows capturing different change values relative to a float voltage, thus determining if the warning system for the vehicles operates stably and safely.

2. Description of the Prior Art

A conventional warning device for vehicles has multi-function and its circuit arrangement is complicated because a lot of sensors are fixed in the warning device. However, such a warning device is complicated and produced at a high cost.

In addition, the conventional warning device still has the following defects:

1. The information can not be read simplifiedly and the maintenance cost is quite high, so utility of the conventional warning device is limited.

2. A water system and an electricity system for the vehicles can not be monitor optionally.

The present invention has arisen to mitigate and/or obviate the afore-described disadvantages.

### SUMMARY OF THE INVENTION

The primary object of the present invention is to provide a warning system of vehicles which allows simplifying circuit a structure and device and allows reading information easily and stabilize the warning system.

Another object of the present invention is to provide a warning system of vehicles which allows to be produced, assembled, and maintained easily and allows prolonging service life.

A warning system of vehicles in accordance with a first embodiment of the present invention contains:

a detecting device for capturing different change values of an internal resistance coefficient generating from a water quantity of an outlet tube of a water tank and different change values relative to a float voltage;

the detecting device connecting with a detection module;

a detection module used to determine the different change values of the internal resistance coefficient generating from the water quantity of the outlet tube of the water tank and captured by the detecting device and to determine the different change values relative to the float voltage, and then to compare the internal resistance coefficient and the float voltage with a predetermined standard coefficient, thus determining if the warning system is normal and amplifying an output signal to make sounds.

Thereby, the warning system of the present invention has the following advantages:

1. The circuit structure of the warning system is easily without matching with a lot of sensors.

2. The warning system is produced and assembled at a low cost.

3. The information of the warning system is sensed by making sounds to decrease maintenance cost.

4. A water supply and an electricity supply are monitored to achieve warning function flexibly.

5. An abnormal water level and an abnormal voltage are monitored by detecting change values of an internal resistance coefficient generating from a water quantity of an outlet tube of a water tank and different change values relative to a float voltage, thus obtaining detection.

### BRIEF DESCRIPTION OF THE DRAWINGS

FIG. 1 is a diagram of a warning system of vehicles according to a first embodiment of the present invention.

FIG. 2 is a diagram of a circuit arrangement of a warning system of vehicles according to the first embodiment of the present invention.

FIG. 3 is a cross sectional view showing a hollow metal connector connecting with two segments of an outlet tube according to the first embodiment of the present invention.

FIG. 4 is a plan view showing the hollow metal connector connecting with a detection module according to the first embodiment of the present invention.

FIG. 5 is a plan view showing a hollow metal connector connecting with a detection module according to a second embodiment of the present invention.

FIG. 6 is a plan view showing a hollow metal connector connecting with a detection module according to a third embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

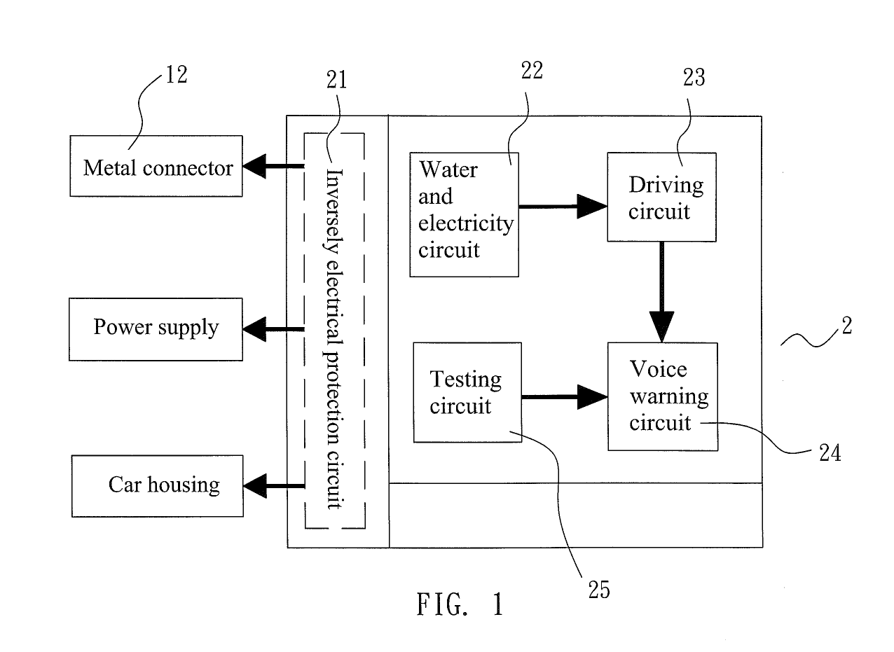

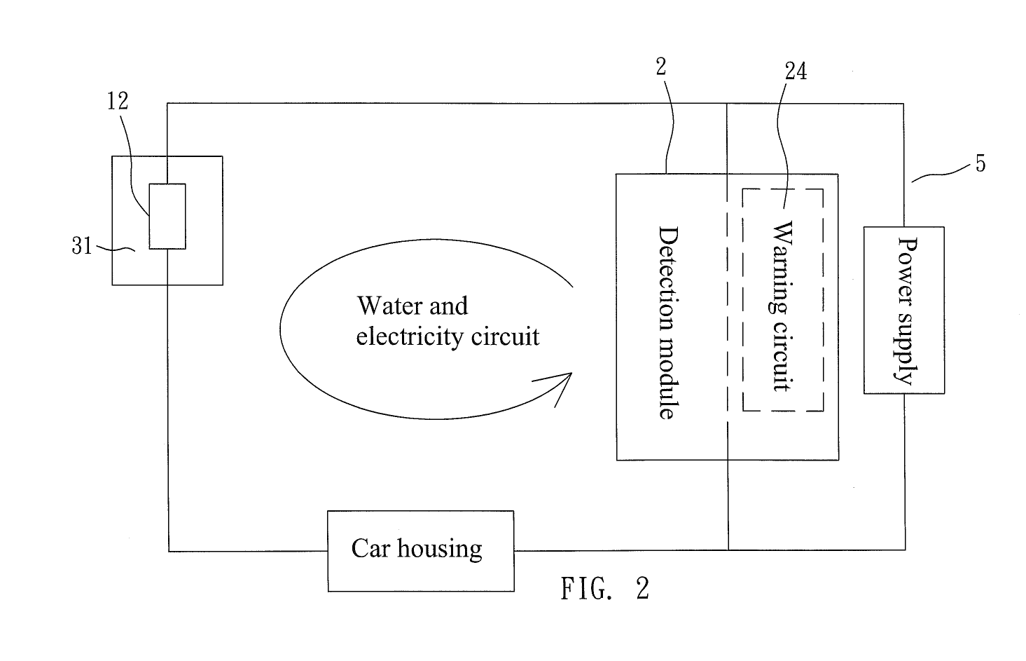

FIGS. 1 and 2, a warning system for vehicles according to a first embodiment of the present invention comprises:

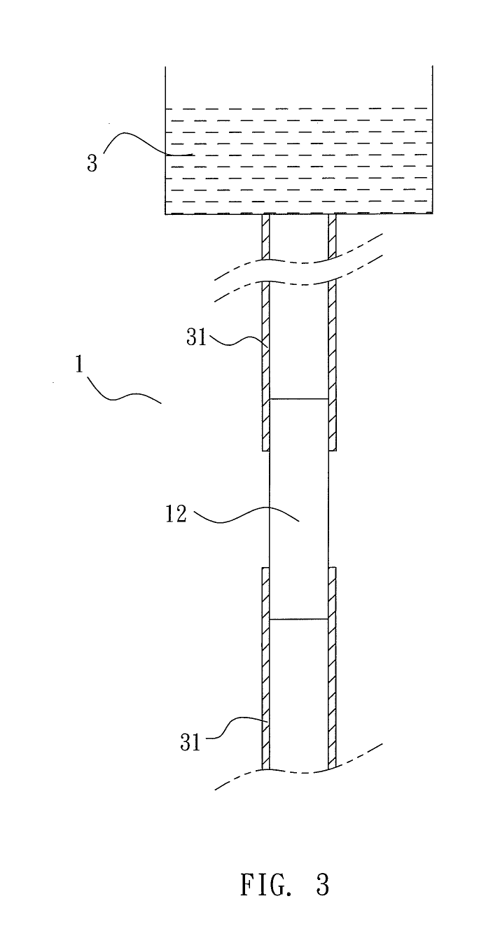

a detecting device 1 for capturing different change values of an internal resistance coefficient generating from a water quantity of an outlet tube 31 of a water tank 3 and different change values relative to a float voltage so as to detect if a water supply and an electricity supply are normal and to transmit an abnormal signal toward a detection module 2, wherein the water supply is determined based on the different change values of the internal resistance coefficient, and the electricity supply is determined based on the different change values relative to the float voltage. Two detection states of the water supply contains: (a) when the outlet tube 31 can not flow any water, the internal resistance coefficient becomes increased, and then the detecting device 1 transmits the abnormal signal toward the detection module 2 and makes sounds continuously; (b) when only less water remains in the outlet tube 31, the less water waves in the outlet tube 31 to obtain a predetermined internal resistance coefficient, hence the detecting device 1 will not transmit the abnormal signal toward the detection module 2 and will not make the warning sounds. If the less water waves in the outlet tube 31 and is under a normal water level, and a change value of the internal resistance coefficient is over a standard value, the water supply is in an abnormal state, and then the detecting device 1 transmits the abnormal signal toward the detection module 2 and makes sounds. Two detection states of the electricity supply contains: (a) when the outlet tube 31 has no any water therein, no matter the electricity supply is normal or not, the detecting device 1 transmits the abnormal signal toward the detection module 2 and makes sounds; (b) when the water quantity of an outlet tube 31 is located at the normal water level, if an electricity system (such as a power generator or a storage battery) generates an abnormal voltage relative to the float voltage, the detecting device 1 transmits the abnormal signal toward the detection module 2 and makes sounds. The detecting device 1 is fixed between the outlet tube 31 of the water tank 3 and a car housing, and two segments of the outlet tube 31 are connected by a hollow metal connector 12 (as shown in FIG. 3).

The detection module 2 is used to determine the different change values of the internal resistance coefficient generating from the water quantity of the outlet tube 31 of the water tank 3 and captured by the detecting device 1 and to determine the different change values relative to the float voltage so as to further determine if a water level of a cooling water of a tank systems is within a normal range and if the electricity system operates normally. In case the tank system or the electricity system operates abnormally, a driving circuit 23 of a water and electricity detecting circuit 22 amplifies the abnormal signal and drives a warning circuit 24 to warn a driver, thus obtaining detection and alert. The detection module 2 includes an inversely electrical protection circuit 21, the water and electricity detecting circuit 22, the driving circuit 23, the warning circuit 24, and a testing circuit 25.

The inversely electrical protection circuit 21 is applied to protect the warning system from operating normally and to prevent an input of a reverse voltage from damaging the warning system. The inversely electrical protection circuit 21 has at least one diode to connect with the detecting device 1, a power supply, the car housing, and the detection module 2 so as to prevent the inverse voltage from inputting into the detection module 2.

The water and electricity detecting circuit 22 is served to receive the internal resistance coefficient and the float voltage captured by the detecting device 1 and to compare the internal resistance coefficient and the float voltage with a predetermined standard coefficient, thus determining if the warning system is normal.

The driving circuit 23 is used to amplify an output signal from the water and electricity detecting circuit 22 to drive the warning circuit 24 to make sounds or voices.

The testing circuit 25 is applied to test the warning system before the warning system operates, and the testing circuit 25 makes sounds to instruct the driver to start the warning system.

FIG. 2 shows the detection module 2, the detecting device 1, and the car housing form an electricity conducting circuit.

In operation, a detecting point of the metal connector 12 captures the different change values of the internal resistance coefficient and the different change values relative to the float voltage to judge if the water level of the cooling water of the tank systems is within the normal range and if the electricity system operates normally. In case the tank system or the electricity system operates abnormally, the driving circuit 23 of the water and electricity detecting circuit 22 amplifies the abnormal signal and drives the warning circuit 24 to warn the driver, thus obtaining detection and alert automatically.

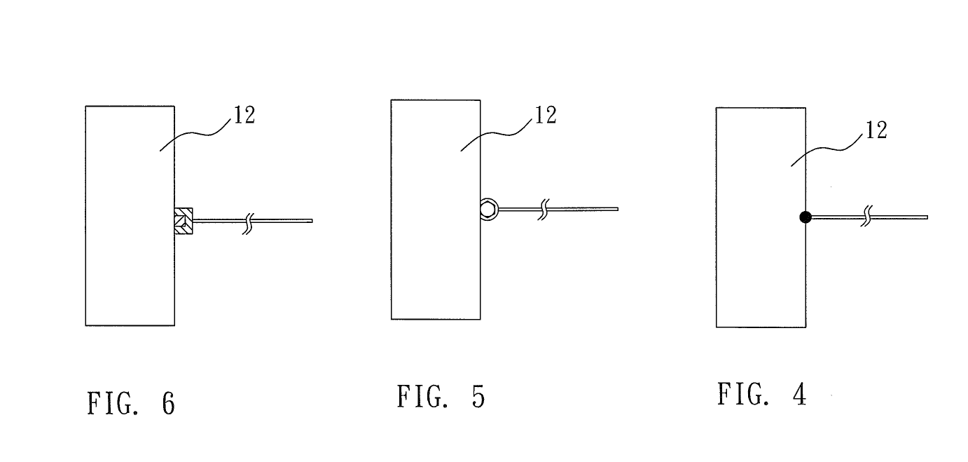

FIGS. 4-6 show the metal connector 12 of the outlet tube 31 being connected with the detection module 2 in a welding manner, a fitting manner, and a screwing manner according to the first embodiment, a second embodiment, and a third embodiment of the present invention respectively.

Thereby, the warning system for the vehicles is provided with the detection module so that the detecting device detects the different change values of the internal resistance coefficient and the different change values relative to the float voltage to further judge if the water level of the cooling water of the tank systems is within the normal range and if the electricity system operates normally.

In case the tank systems or the electricity system operates abnormally, the driving circuit of the water and electricity detecting circuit 22 amplifies the abnormal signal and drives the warning circuit 24 to warn the driver, thus obtaining detection and alert automatically.

While we have shown and described various embodiments in accordance with the present invention, it is clear to those skilled in the art that further embodiments may be made without departing from the scope of the present invention.

What is claimed is:

1. A warning system for vehicles comprising:
a detecting device for capturing different change values of an internal resistance coefficient generating from a water quantity of an outlet tube of a water tank and different change values relative to a float voltage;
the detecting device connecting with a detection module;
a detection module used to determine the different change values of the internal resistance coefficient generating from the water quantity of the outlet tube of the water tank and captured by the detecting device and to determine the different change values relative to the float voltage, and then to compare the internal resistance coefficient and the float voltage with a predetermined standard coefficient, thus determining if the warning system is normal and amplifying an output signal to make sounds;
thereby the detection module, the detecting device, and a car housing form an electricity conducting circuit so that detection and alert are obtained automatically

2. The warning system for vehicles as claimed in claim 1, wherein the detecting device is fixed between the outlet tube of the water tank and the car housing, and two segments of the outlet tube are connected by a hollow metal connector.

3. The warning system for vehicles as claimed in claim 1, wherein the detection module includes:
an inversely electrical protection circuit applied to protect the warning system from operating normally and to prevent an input of a reverse voltage from damaging the warning system;
a water and electricity detecting circuit served to receive the internal resistance coefficient and the float voltage captured by the detecting device and to compare the internal resistance coefficient and the float voltage with a predetermined standard coefficient, thus determining if the warning system is normal.
a driving circuit used to amplify the output signal from the water and electricity detecting circuit to drive the warning circuit to make sounds or voices;
a testing circuit applied to test the warning system before the warning system operates, and the testing circuit making sounds to instruct a driver to start the warning system.
